(19) United States
(12) Patent Application Publication
(10) Pub. No.: US 2022/0162524 A1
(43) Pub. Date: May 26, 2022

(54) ANTI-FOGGING LENS CLEANING SOLUTIONS AND RELATED KITS AND METHODS

(71) Applicant: ZClear Anti Fog Inc., Ogden, UT (US)

(72) Inventor: Christopher J. Ward, North Ogden, UT (US)

(21) Appl. No.: 17/531,659

(22) Filed: Nov. 19, 2021

Related U.S. Application Data
(60) Provisional application No. 63/116,667, filed on Nov. 20, 2020.

(51) Int. Cl. C11D 3/00; C11D 1/83; C11D 3/04; C11D 3/20; C11D 3/37; C11D 3/48; C11D 3/43; C11D 11/00; C11D 17/04; B08B 3/08; B08B 1/00; G02C 13/00

(52) U.S. Cl. CPC C11D 3/0078; C11D 1/83; C11D 3/046; C11D 3/201; C11D 3/3707; C11D 3/48; C11D 1/146; C11D 11/0035; C11D 17/049; B08B 3/08; B08B 1/006; G02C 13/006; C11D 3/43

(57) ABSTRACT

Formulations for anti-fogging wipes and/or sprays for transparent and reflective surfaces, such as glasses and/or lenses, along with related methods and kits comprising both wet and dry wipes. In some embodiments, a kit may be provided that may comprise a plurality of dual-compartment packages, each of which may contain a wet wipe container/side having a wet wipe treated with an anti-fogging solution and a separate dry wipe container having a dry wipe for use in removing excess cleaning solution from a lens or other transparent or reflective surface that may be prone to fogging.

### CROSS-REFERENCE TO RELATED APPLICATIONS

This application claims the benefit of U.S. Provisional Patent Application No. 63/116,667, filed Nov. 20, 2020 and titled “ANTI-FOGGING LENS CLEANING SOLUTIONS AND RELATED KITS AND METHODS,” which is hereby incorporated herein by reference in its entirety.

### SUMMARY

Embodiments of apparatus, kits/systems, and methods are disclosed herein that relate to anti-fogging solutions for use in cleaning and inhibiting fogging of transparent and reflective surfaces, such as, for example, glasses, goggles, face shields, face masks, mirrors, camera lenses, and screens for electronic devices.

In some implementations and embodiments, kits may be provided that include both wet wipes, which may comprise various formulations for cleaning and anti-fogging, as disclosed herein, along with dry wipes to allow the user to thoroughly clean and de-fog their glasses, or another transparent or reflective surface, and then wipe them dry immediately thereafter so that they are ready for immediate, continued use, if desired.

In a more specific example of an anti-fogging cleaning kit according to some embodiments, the kit may comprise a plurality of individual packages each having two separate compartments, one of which contains a wet wipe having an anti-fogging, cleaning solution contained therein to keep the wipe wet and the other of which contains a dry wipe that may be used to remove the solution after it has been applied to the lenses of a pair of glasses or any other transparent or reflective surface in need of cleaning and/or anti-fogging.

In some embodiments, the wet wipe solution may comprise a combination of Triclosan or another suitable antimicrobial/disinfectant, Sodium Lauryl Sulfate (K12), Lauryl Amine oxide, Ethanol, Sodium Chloride, Poly Propylene Glycol-26, and water, preferably in one of the concentrations provided herein. In some embodiments, the wet wipe solution may contain little to no alcohols, such as less than or equal to about 75% weight by volume in preferred embodiments, less than or equal to about 3% weight by volume in some such embodiments, and less than or equal to about 1% weight by volume in some such embodiments. In some embodiments, the solution may be provided in a spray bottle, preferably with some wipes, which may be dry wipes, to facilitate ease of use.

In an example of a method for cleaning and defogging a pair of glasses using a kit, the method may comprise opening a first compartment of a package, the first compartment containing a wet wipe and a cleaning and anti-fogging solution. In some embodiments and implementations, the cleaning and anti-fogging solution may comprise a thickening agent and/or a surfactant. In some such embodiments, the thickening agent and/or surfactant may be present in an amount between about 0.05% and about 0.25% of the solution. In some embodiments and implementations, the solution may further comprise an antimicrobial agent, such as ethanol and/or triclosan. In some embodiments and implementations, the solution may comprise a surfactant in an amount between about 0.05% and about 0.15% of the solution.

The method may further comprise using the wet wipe to apply the cleaning and anti-fogging solution to lenses of a pair of glasses and opening a second compartment of the packages, the second compartment containing a dry wipe. The dry wipe may then be used to at least substantially remove the cleaning and anti-fogging solution from the lenses.

In some embodiments and implementations, the cleaning and anti-fogging solution may comprise sodium lauryl sulfate, lauryl amine oxide, and/or poly propylene glycol.

In some embodiments and implementations, the step of using the wet wipe to apply the cleaning and anti-fogging solution to the lenses may comprise using the wet wipe to rub the cleaning and anti-fogging solution into the lenses multiple times (in some cases, three, or more, times) prior to using the dry wipe to at least substantially remove the cleaning and anti-fogging solution from the lenses, in some cases with a pause between each application.

In some embodiments and implementations, the thickening agent and/or surfactant may comprise sodium lauryl sulfate in an amount between about 0.03% and about 0.1% of the solution and lauryl amine oxide in an amount between about 0.05% and about 0.15% of the solution.

In a specific example of a kit for cleaning and defogging a pair of glasses according to some embodiments, the kit may comprise a plurality of packages, each package comprising a wet compartment and a dry compartment fluidly separated from the wet compartment. A wet wipe may be contained within the wet compartment of each of the plurality of packages and may be present in the wet compartment along with a cleaning and anti-fogging solution. In some embodiments, the cleaning and anti-fogging solution may comprise sodium lauryl sulfate, lauryl amine oxide, poly propylene glycol, and/or ethanol. In some such embodiments, the ethanol may be present in the solution in an amount below about 75% of the solution. A dry wipe may be contained within each dry compartment of each of the plurality of packages, which preferably may be separated from the wet compartment of each package with a tear line or other weakened portion to facilitate separation of the two compartments.

In some embodiments, the cleaning and anti-fogging solution may further comprise another antimicrobial ingredient, such as triclosan. In some such embodiments, the triclosan may be present in the cleaning and anti-fogging solution in a concentration of between about 0.05% and about 0.15%.

In some embodiments, the ethanol may be present in the cleaning and anti-fogging solution in a concentration of less than 3%. In some such embodiments, the ethanol may be present in the cleaning and anti-fogging solution in a concentration of less than 1%.

In another example of a kit for cleaning and defogging a pair of glasses according to other embodiments, the kit may comprise a package comprising a plurality of compartments, wherein each compartment of the plurality of compartments is fluidly separated from each remaining compartment of the plurality of compartments. A wet wipe may be contained within a first compartment of each of the plurality of compartments, wherein the wet wipe is contained in the first compartment with a cleaning and anti-fogging solution.

In some embodiments, the cleaning and anti-fogging solution may comprise a thickening agent, a surfactant, and/or an alcohol, such as ethanol, in an amount preferably below about 75% of the solution. In some such embodiments, the ethanol or other alcohol may be present in the cleaning and anti-fogging solution in a concentration of less than about 3%.

A dry wipe may be contained within a second compartment of each of the plurality of compartments.

In some embodiments, the wet wipe and/or the dry wipe may comprise a non-woven fabric.

In some embodiments, the cleaning and anti-fogging solution may comprise sodium lauryl sulfate, lauryl amine oxide, poly propylene glycol, and/or sodium chloride.

In some embodiments, the sodium lauryl sulfate may be present in the cleaning and anti-fogging solution in a concentration of between about 0.03% and about 0.1% w/v, the lauryl amine oxide may be present in the cleaning and anti-fogging solution in a concentration of between about 0.05% and about 0.15% w/v, the poly propylene glycol may be present in the cleaning and anti-fogging solution in a concentration of between about 0.05% and about 0.15% w/v, and/or the sodium chloride may be present in the cleaning and anti-fogging solution in a concentration of between about 0.05% and about 0.15% w/v.

In some embodiments, the cleaning and anti-fogging solution may further comprise triclosan, which in some such embodiments may be present in the solution in a concentration of between about 0.015% and about 0.15%.

The features, structures, steps, or characteristics disclosed herein in connection with one embodiment may be combined in any suitable manner in one or more alternative embodiments.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1 is a plan view of a wipe packet, which may be provided in a kit in some embodiments, that includes both wet wipes having anti-fogging solution, and dry wipes in a separate compartment;

FIG. 2 depicts the wipe packets of FIG. 1 separated and opened to reveal the wipes contained therein;

FIG. 3 depicts the lenses of a pair of glasses being cleaned using an anti-fogging wet wipe;

FIG. 4 depicts the lenses of a pair of glasses being dried using a dry wipe; and

FIG. 5 depicts the lenses of a pair of glasses being cleaned using an anti-fogging spray solution and a wipe.

### DETAILED DESCRIPTION

It will be readily understood that the components of the present disclosure, as generally described and illustrated in the drawings herein, could be arranged and designed in a wide variety of different configurations. Thus, the following more detailed description of the embodiments of the apparatus is not intended to limit the scope of the disclosure but is merely representative of possible embodiments of the disclosure. In some cases, well-known structures, materials, or operations are not shown or described in detail.

As used herein, the term “substantially” refers to the complete or nearly complete extent or degree of an action, characteristic, property, state, structure, item, or result to function as indicated. For example, an object that is “substantially” cylindrical or “substantially” perpendicular would mean that the object/feature is either cylindrical/perpendicular or nearly cylindrical/perpendicular so as to result in the same or nearly the same function. The exact allowable degree of deviation provided by this term may depend on the specific context. The use of “substantially” is equally applicable when used in a negative connotation to refer to the complete or near complete lack of an action, characteristic, property, state, structure, item, or result. For example, structure which is “substantially free of” a bottom would either completely lack a bottom or so nearly completely lack a bottom that the effect would be effectively the same as if it completely lacked a bottom.

Similarly, as used herein, the term “about” is used to provide flexibility to a numerical range endpoint by providing that a given value may be “a little above” or “a little below” the endpoint while still accomplishing the function associated with the range.

The embodiments of the disclosure may be best understood by reference to the drawings, wherein like parts may be designated by like numerals. It will be readily understood that the components of the disclosed embodiments, as generally described and illustrated in the figures herein, could be arranged and designed in a wide variety of different configurations. Thus, the following detailed description of the embodiments of the apparatus and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified. Additional details regarding certain preferred embodiments and implementations will now be described in greater detail with reference to the accompanying drawings.

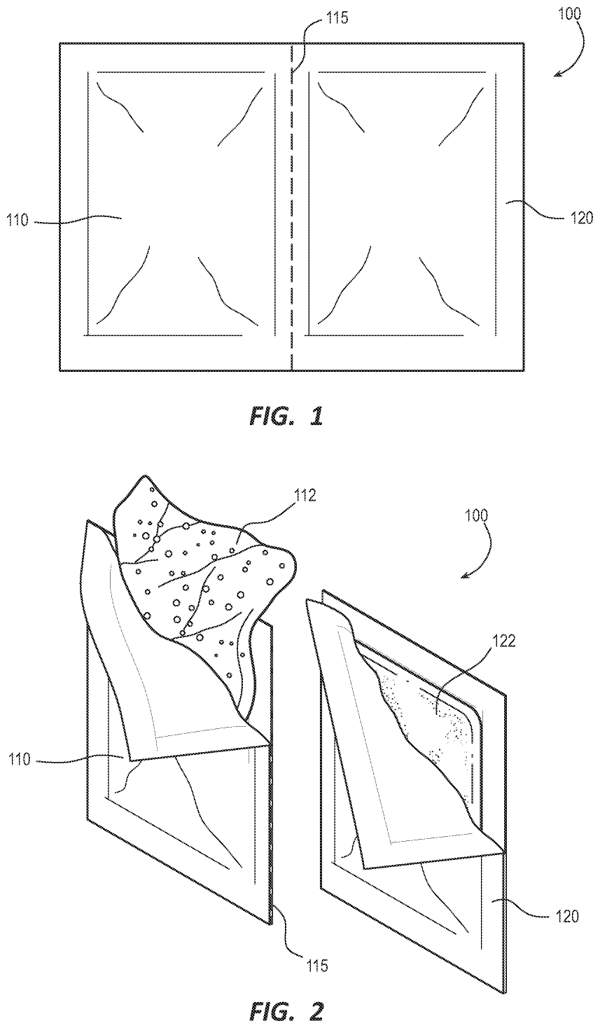

FIG. 1 depicts a packaged pair of wipes 100. In some cases, package 100 may be sold as part of a kit, which may include a plurality of such packages 100. In some cases, additional elements may be included in the kit, such as anti-fogging sprays, pastes, reusable cloths, and the like. In the depicted embodiment, package 100 includes two separate compartments, namely, a wet wipe compartment 110 and a dry wipe compartment 120, separated by a tear line 115. In this manner, a user can easily obtain everything needed to thoroughly clean and de-fog one or more lenses, such as the lenses on a pair of glasses, for example, by obtaining and using a single package 100.

FIG. 2 depicts package 100 after being opened to allow for access to the wet wipe 112 within compartment 110 and the dry wipe 122 within its compartment 120. A relatively small amount of cleaning solution, preferred formulations of which are described below, may be present in compartment 110 to maintain moisturization of the wet wipe 112 therein. The wipes 112 and 122 are preferably made from a non-woven fabric, which may include materials such as cotton, wood pulp, Rayon, polyester, and polypropylene, for example.

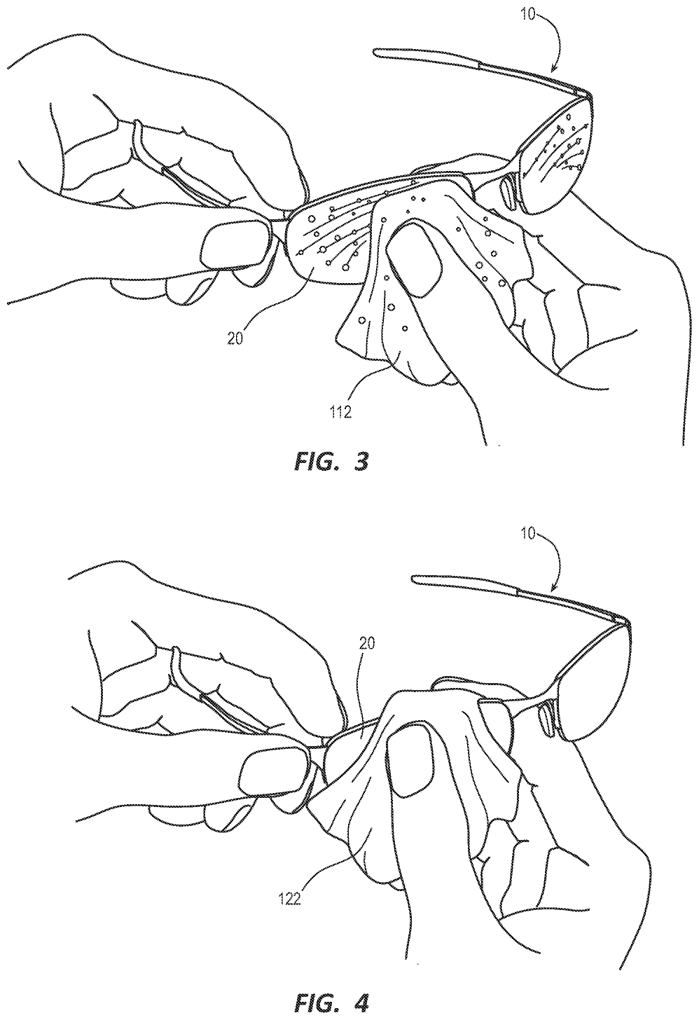

FIGS. 3 and 4 depict the lenses 20 of a pair of glasses 10 being cleaned and de-fogged. As shown in FIG. 3, in certain inventive methods according to preferred implementations of the invention, wet wipe 112 is first used to clean and liberally apply cleaning solution to lenses 20. In preferred embodiments and implementations, the wet wipe 112 is used to agitate dirt, dust, smudges, and other undesired substances from the lenses 20, and also to apply a generous amount of the solution to the lenses. If certain preferred formulations of the cleaning solution are used, this solution may result in prolonged antifogging of lenses 20 in addition to cleaning the lenses 20. As shown in FIG. 4, after thoroughly cleaning the lenses 20 using the wet wipe 112, a dry wipe 122 may be used to remove excess solution that may otherwise obscure vision through the lenses 20 to allow for immediate wearing of glasses 10.

In preferred implementations of methods involving use of the wet wipe 112 and dry wipe 122, preferably packaged together for convenience, the inventor has discovered that better results may be achieved by repeating the steps using the wet wipe 112 multiple times. Thus, in a particularly preferred method, wet wipe 112 may be used to fully apply the solution thereon to the lenses 20 (preferably both sides) three times (but could be two or more than three in alternative implementations) prior to using the dry wipe 122 to complete the de-fogging and cleaning process.

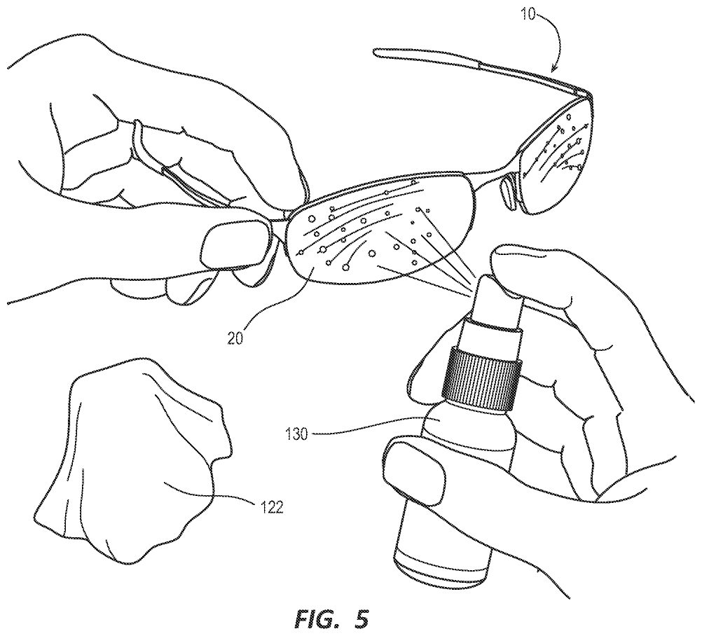

FIG. 5 depicts a spray bottle 130 that may include a cleaning and/or anti-fogging solution according to one or more embodiments or implementations of the invention described herein. Once again, the lenses 20 of a pair of glasses 10 are shown being cleaned with the solution in spray bottle 130, which may be provided with kits according to alternative embodiments. A wipe 122 is also depicted, which may, but need not, comprise a dry wipe since the anti-fogging solution is provided in a spray bottle 130 rather than in a separate wipe.

In preferred implementations of methods using a spray bottle of cleaning and/or anti-fogging solution, such as spray bottle 130, the method may include one or more stages or steps involving use of the finger or fingers of the user applying the solution. This is because the inventor has discovered that spraying the solution and using a wipe 122 alone typically does not allow the solution to dry on the lens properly. Thus, in preferred implementations, the solution may be sprayed onto the lens and then rubbed into the lens, preferably on both sides, using one of more fingers. After this, a wipe, such as dry wipe 122, may be used to remove any fingerprints, dust, or remaining solution by wiping the lenses. A similar method may also be used in connection with the aforementioned wipes. Thus, for example, in addition, to using the wet wipe to rub the solution into the lens, in some cases the user may rub the solution into the lens using a finger.

Specific examples of preferred formulations of anti-fogging solutions are disclosed below. Unless otherwise stated, each of the ingredient concentrations provided below is presented in a percent of weight by volume.

### Example 1

| | |
|---|---|
| Triclosan | about 0.10% |
| Sodium Lauryl Sulfate | about 0.05% |
| (K12) | |
| Lauryl Amine oxide | about 0.10% |
| Ethanol | about 1% |
| Sodium Chloride | about 0.10% |
| Poly Propylene Glycol-26 | about 0.10% |
| Essence (fragrance) | about 0.05% |
| Food Colorant | about 0.02% |
| Purified Water | about 98.5% |

As those of ordinary skill in the art will appreciate, the concentrations in the formulation referenced above may vary in alternative embodiments. Thus, the following example contains suitable ranges for various ingredients. It should also be understood, however, that some ingredients may be omitted and/or replaced with alternative ingredients, as set forth in other examples below.

### Example 2

| Triclosan | about 0.05% to about |
|---|---|
| | 0.15% |
| Sodium Lauryl Sulfate | about 0.03% to about |
| (K12) | 0.1% |
| Lauryl Amine oxide | about 0.05% to about |
| | 0.15% |
| Ethanol | about 0.05% to about |
| | 3% |
| Sodium Chloride | about 0.05% to about |
| | 0.15% |
| Poly Propylene Glycol-26 | about 0.05% to about |
| | 0.15% |
| Essence (fragrance) | about 0.05% to about |
| | 1% |
| Food Colorant | about 0.01% to about |
| | 0.03% |
| Purified Water | about 95% to about |
| | 99% |

In addition to the ranges presented in the example above, some of the ingredients may be omitted and/or replaced with alternative ingredients. For example, antimicrobial/disinfectant agents other than triclosan and ethanol may be substituted in alternative formulations or may be omitted entirely if desired. In some embodiments, surfactants and/or thickening agents other than Sodium Lauryl Sulfate (K12) and/or Poly Propylene Glycol may be used. Some ingredients, such as food colorant and fragrance/essence, may be omitted entirely if desired.

In addition, most existing solutions contain relative high concentrations of ethanol or other types of alcohol, which can have negative effects such as eroding the reflective surface of sunglasses, for example. Thus, in preferred formulations, the concentration of ethanol and/or alcohol may be less than about 3%. More preferably, the concentration is about 1% or less. In some such formulations, there may be no, or at least substantially no, alcohol at all. Thus, any of the specific examples contained herein may be modified to reduce or eliminate ethanol and/or other types of alcohol, in some cases altogether, if desired, in order to reduce or eliminate the negative effects of such ingredients in anti-fogging and cleaning solutions.

However, for certain purposes, a higher amount of ethanol or other alcohol may be used. Thus, the following example provides a formulation that may be higher in ethanol and may still be suitable for certain applications.

### Example 3

| Triclosan | about 0.05% to about |
|---|---|
| | 0.15% |
| Sodium Lauryl Sulfate | about 0.03% to about |
| (K12) | 0.1% |
| Lauryl Amine oxide | about 0.05% to about |
| | 0.15% |
| Ethanol | about 3% to about |
| | 75% |
| Sodium Chloride | about 0.05% to about |
| | 0.15% |
| Poly Propylene Glycol-26 | about 0.05% to about |
| | 0.15% |
| Essence (fragrance) | about 0.05% to about |
| | 1% |
| Food Colorant | about 0.01% to about |
| | 0.03% |
| Purified Water | about 24% to about |
| | 97% |

In an example of a method for manufacturing an anti-fogging lens solution, 50 kg of purified water may be obtained and set aside for later use. Additional water may then be heated to about 85 degrees Celsius, after which the heated water may be added to the Sodium Lauryl Sulfate until the Sodium Lauryl Sulfate is fully dissolved. The triclosan or other antimicrobial/disinfectant may then be added to the ethanol until fully dissolved, after which the dissolved Sodium Lauryl Sulfate solution may be added to the purified water. The remainder of the ingredients may then be added, after which addition purified water may be added to the solution until it reaches about 100 kg in total. Of course, solution batches of other sizes may be made by decreasing, or increasing, these various ingredients proportionally.

It is contemplated that any of the solutions disclosed herein may be used in connection with wipes or, alternatively, sprays, if made with the correct viscosity. As will be readily appreciated by those of ordinary skill in the art, the coloring may be options. As those of ordinary skill in the art will also readily appreciate, the amounts provided in the chart may vary proportionally as desired.

It will be understood by those having skill in the art that changes may be made to the details of the above-described embodiments without departing from the underlying principles presented herein. Any suitable combination of various embodiments, or the features thereof, is contemplated.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Throughout this specification, any reference to “one embodiment,” “an embodiment,” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, inventive aspects lie in a combination of fewer than all features of any single foregoing disclosed embodiment. It will be apparent to those having skill in the art that changes may be made to the details of the above-described embodiments without departing from the underlying principles set forth herein.

Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, a required, or an essential feature or element.

The scope of the present inventions should, therefore, be determined only by the following claims.

1. A method for cleaning and defogging a pair of glasses using a kit, the method comprising the steps of:
opening a first compartment of a package, the first compartment containing a wet wipe and a cleaning and anti-fogging solution, wherein the cleaning and anti-fogging solution comprises:
a thickening agent and/or a surfactant in an amount between about 0.05% and about 0.25% of the solution;
an antimicrobial agent; and
using the wet wipe to apply the cleaning and anti-fogging solution to lenses of a pair of glasses;
opening a second compartment of the packages, the second compartment containing a dry wipe; and
using the dry wipe to at least substantially remove the cleaning and anti-fogging solution from the lenses.

2. The method of claim 1, wherein the cleaning and anti-fogging solution comprises:
sodium lauryl sulfate; and
lauryl amine oxide.

3. The method of claim 1, wherein the step of using the wet wipe to apply the cleaning and anti-fogging solution to the lenses comprises using the wet wipe to rub the cleaning and anti-fogging solution into the lenses multiple times prior to using the dry wipe to at least substantially remove the cleaning and anti-fogging solution from the lenses.

4. The method of claim 3, wherein the step of using the wet wipe to apply the cleaning and anti-fogging solution to the lenses comprises using the wet wipe to rub the cleaning and anti-fogging solution into the lenses three times prior to using the dry wipe to at least substantially remove the cleaning and anti-fogging solution from the lenses with a pause between each application.

5. The method of claim 1, wherein the thickening agent and/or a surfactant comprises:
sodium lauryl sulfate in an amount between about 0.03% and about 0.1% of the solution; and
lauryl amine oxide in an amount between about 0.05% and about 0.15% of the solution.

6. A kit for cleaning and defogging a pair of glasses, comprising:
a plurality of packages, each package comprising a wet compartment and a dry compartment fluidly separated from the wet compartment;
a wet wipe contained within the wet compartment of each of the plurality of packages, wherein the wet compartment comprises a cleaning and anti-fogging solution, wherein the cleaning and anti-fogging solution comprises:
sodium lauryl sulfate;
lauryl amine oxide;
poly propylene glycol; and
ethanol in an amount below about 75% of the solution; and
a dry wipe contained within the dry compartment of each of the plurality of packages.

7. The kit of claim 6, wherein the cleaning and anti-fogging solution further comprises triclosan.

8. The kit of claim 7, wherein the triclosan is present in the cleaning and anti-fogging solution in a concentration of between about 0.05% and about 0.15%.

9. The kit of claim 6, wherein the ethanol is present in the cleaning and anti-fogging solution in a concentration of less than 3%.

10. The kit of claim 9, wherein the ethanol is present in the cleaning and anti-fogging solution in a concentration of less than 1%.

11. A kit for cleaning and defogging a pair of glasses, comprising:
a package comprising a plurality of compartments, wherein each compartment of the plurality of compartments is fluidly separated from each remaining compartment of the plurality of compartments;
a wet wipe contained within a first compartment of each of the plurality of compartments, wherein the wet wipe is contained in the first compartment with a cleaning and anti-fogging solution, wherein the cleaning and anti-fogging solution comprises:
a thickening agent;
a surfactant; and
an alcohol in an amount below about 75% of the solution; and
a dry wipe contained within a second compartment of each of the plurality of compartments.

12. The kit of claim 11, wherein the wet wipe comprises a non-woven fabric.

13. The kit of claim 12, wherein the dry wipe comprises a non-woven fabric.

14. The kit of claim 13, wherein the wet wipe and the dry wipe comprise the same type of non-woven fabric.

15. The kit of claim 11, wherein the alcohol comprises ethanol.

16. The kit of claim 15, wherein the ethanol is present in the cleaning and anti-fogging solution in a concentration of less than about 75%.

17. The kit of claim 16, wherein the ethanol is present in the cleaning and anti-fogging solution in a concentration of less than about 3%.

18. The kit of claim 11, wherein the cleaning and anti-fogging solution comprises:
sodium lauryl sulfate;
lauryl amine oxide;
poly propylene glycol; and
sodium chloride.

19. The kit of claim 18, wherein the sodium lauryl sulfate is present in the cleaning and anti-fogging solution in a concentration of between about 0.03% and about 0.1% w/v, wherein the lauryl amine oxide is present in the cleaning and anti-fogging solution in a concentration of between about 0.05% and about 0.15% w/v, wherein the poly propylene glycol is present in the cleaning and anti-fogging solution in a concentration of between about 0.05% and about 0.15% w/v, and wherein the sodium chloride is present in the cleaning and anti-fogging solution in a concentration of between about 0.05% and about 0.15% w/v.

20. The kit of claim 19, wherein the cleaning and anti-fogging solution further comprises triclosan in a concentration of between about 0.015% and about 0.15%.
